(19) United States
(12) Patent Application Publication
(10) Pub. No.: US 2026/0321133 A1
(43) Pub. Date: Oct. 15, 2026

(54) URBAN TRANSPORTION CONTROL SYSTEM AND METHOD OF IMPLEMENTING SAME

(71) Applicant: Dhruva Sharma, Fort Myers, FL (US)

(72) Inventor: Dhruva Sharma, Fort Myers, FL (US)

(21) Appl. No.: 19/465,213

(22) Filed: Jan. 30, 2026

Related U.S. Application Data
(60) Provisional application No. 63/751,541, filed on Jan. 30, 2025.

(51) Int. Cl. G08G 1/081; E01F 9/559; G08G 1/01; G08G 1/04; G08G 1/054

(52) U.S. Cl. CPC G08G 1/081; E01F 9/559; G08G 1/0133; G08G 1/0141; G08G 1/04; G08G 1/054

(57) ABSTRACT

A system to provide urban transportation control can perform operations that include receiving traffic camera feeds from traffic cameras distributed across a multi-path traffic flow area, analyzing the traffic camera feeds to determine a position of one or more vehicles in the multi-path traffic flow area, and generating a traffic signal control plan to adjust a timing schedule of one or more traffic signals of the multi-path traffic flow area based on the position of the one or more vehicles. The operations can also include transmitting a plurality of traffic signal control commands to the one or more traffic signals based on the traffic signal control plan, monitoring for distracted drivers using machine learning based on the traffic camera feeds, and transmitting a distracted driver alert based on detecting at least one distracted driver exceeding an erratic vehicle operation threshold in the multi-path traffic flow area.

### CROSS-REFERENCE TO RELATED APPLICATIONS

This application claims the benefit of United States Application No. 63/751,541, filed Jan. 30, 2025, the contents of which are incorporated by reference herein in their entirety.

### FIELD OF THE INVENTION

The disclosure relates to a transportation control system, and more particularly to an urban transportation control system and a method for implementing the same.

### BACKGROUND

Traffic control systems that are currently in place are far from efficient and many are static systems, meaning that the systems are time-based and thus, do not adapt well to varying traffic patterns. Traffic lights that are static, or that have fixed timing patterns, can create several problems for drivers and pedestrians alike. Fixed traffic lights may not adjust to the changes in traffic patterns in real time and may cause congestion and frustrating delays. Moreover, a lack of synchronization among traffic lights can cause drivers to encounter a series of red lights along a certain stretch of roadway, thereby exacerbating delay issues. Static traffic lights can also pose safety concerns, especially for pedestrians, as such traffic lights may not provide an adequate amount of time for pedestrians to cross the street, thereby increasing the likelihood of accidents. This may inevitably lead to traffic congestion which further leads to long wait times, increased travel times and a decrease in efficiency for individuals and other entities. Additionally, static traffic control systems do not take into account real-time traffic data, such as accidents or road closures, and thus, can significantly affect traffic flow. This in turn can lead to increased congestion and prolonged travel times, which may also result in decreased fuel efficiency as vehicles that are stuck in traffic burn more fuel. Further, idling vehicles stuck in traffic emit more exhaust, thereby contributing to a reduced air quality, pollution and environmental degradation, and possible health consequences.

### SUMMARY

Embodiments of the present disclosure may be used to provide urban transportation control. In some embodiments, a system can perform operations that include receiving traffic camera feeds from traffic cameras distributed across a multi-path traffic flow area, analyzing the traffic camera feeds to determine a position of one or more vehicles in the multi-path traffic flow area, and generating a traffic signal control plan to adjust a timing schedule of one or more traffic signals of the multi-path traffic flow area based on the position of the one or more vehicles. The operations can also include transmitting a plurality of traffic signal control commands to the one or more traffic signals based on the traffic signal control plan, monitoring for distracted drivers using machine learning based on the traffic camera feeds, and transmitting a distracted driver alert based on detecting at least one distracted driver exceeding an erratic vehicle operation threshold in the multi-path traffic flow area.

The present disclosure includes various methods, apparatuses (including computer systems) that perform such methods, and computer readable media containing instructions that, when executed by computing systems, cause the computing systems to perform such methods.

Other features will be apparent from the accompanying drawings and from the detailed description which follows.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a traffic monitoring and control system according to one or more embodiments described herein;

FIG. 2 is a block diagram of a system in accordance with various embodiments described herein;

FIG. 3 is a block diagram of a control system in accordance with various embodiments described herein;

FIG. 4 is a block diagram of an adaptive road stud device in accordance with various embodiments described herein;

FIG. 5 is a block diagram of a vision pipeline in accordance with various embodiments described herein;

FIG. 6 is a block diagram of an agent of traffic planner model in accordance with various embodiments described herein;

FIG. 7 is a flow diagram of a method according to one or more embodiments described herein; and

FIG. 8 depicts a block diagram of a processing system for implementing one or more embodiments described herein.

The diagrams depicted herein are illustrative. There can be many variations to the diagram or the operations described therein without departing from the scope of the embodiments described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein relate to urban transportation control systems that modify aspects of a multi-path traffic flow area. Control aspects can include changing traffic light timing from a default schedule to an adaptive schedule that corresponds to current and predicted traffic patterns.

As one example, Boston is the second worst city in the country and 3rd worst worldwide, for traffic congestion. On average, Boston drivers can lose 134 hours each year battling traffic. Vehicles can be stuck at traffic signals for minutes at a time with no other vehicles in sight, just waiting for the signal to turn green. One way to fix this is to allow traffic to pass when there are no other vehicles in sight coming from other directions. However, the majority of traffic systems are static, meaning the systems are time-based and do not adapt to varying traffic patterns. Traffic lights that are static, or fixed in their timing patterns, can create several problems for drivers and pedestrians. Fixed traffic lights may not adjust to the changes in traffic patterns in real time, causing congestion and unnecessary delays. Moreover, the lack of synchronization among traffic lights can cause drivers to face a series of red lights, exacerbating the delay issue. Static traffic lights can also pose safety concerns, especially for pedestrians. The traffic lights may not provide adequate time for people to cross the street, increasing the likelihood of accidents.

In an embodiment, an innovative urban transportation solution is provided by developing a comprehensive and multifaceted solution utilizing Artificial Intelligence, where the system leverages real-world data to dynamically optimize traffic flow, ensuring adaptive responses to various traffic scenarios in real time. An overarching goal is to enhance the landscape of urban transportation by addressing critical challenges in real-time traffic signal control, road safety, and traffic accident prevention. This multidimensional approach combines various technologies, including computer vision, machine learning, and advanced optimization algorithms, to create a comprehensive and intelligent system that may not only optimize traffic flow but also ensures road safety and can reduce traffic accidents.

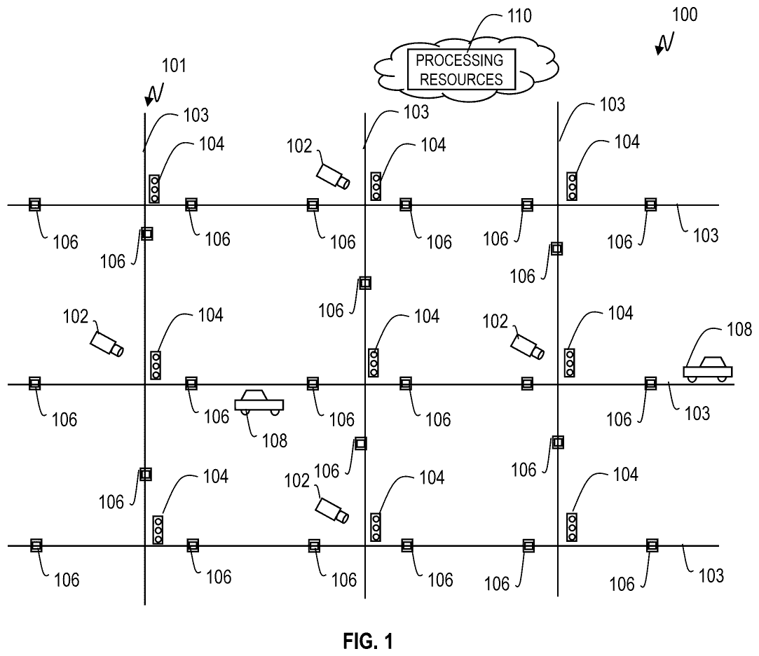

FIG. 1 depicts a block diagram of a traffic monitoring and control system according to one or more embodiments described herein. System 100 of FIG. 1 includes a plurality of traffic cameras 102 distributed across a multi-path traffic flow area 101 that can include streets 103 that intersect one or more other streets 103. The system 100 can control signal timing (e.g., red-yellow-green light) transitions of a plurality of traffic signals 104 distributed throughout the multi-path traffic flow area 101. In some aspects, adaptive road studs 106 can be embedded within the one or more of the streets 103 to provide visual guidance to vehicles 108, as the vehicles travel throughout the multi-path traffic flow area 101, creating traffic patterns that can vary over a period of time. The adaptive road studs 106 can be placed between travel lanes of the streets 103 and can provide visual indications to traffic moving in opposite directions. Timing of the traffic signals 104 can be dynamically adjusted by processing resources 110 that are configured to determine traffic timing optimization across the multi-path traffic flow area 101. The processing resources 110 can also interact with the traffic cameras 102 to collect visual traffic information. The processing resources 110 can also interface with the adaptive road studs 106 to collect traffic information and/or update visual status output of the adaptive road studs 106 in one or more directions of travel of vehicles 108. Although the multi-path traffic flow area 101 is depicted in a particular arrangement in FIG. 1, it will be understood that any distribution of streets 103, traffic cameras 102, traffic signals 104, and/or adaptive road studs 106 is contemplated, including complex configurations, such as multiple lanes of travel, one-way streets, shared turning lanes, multiple turning lanes, rotaries, railroad crossing gates, and other configurations.

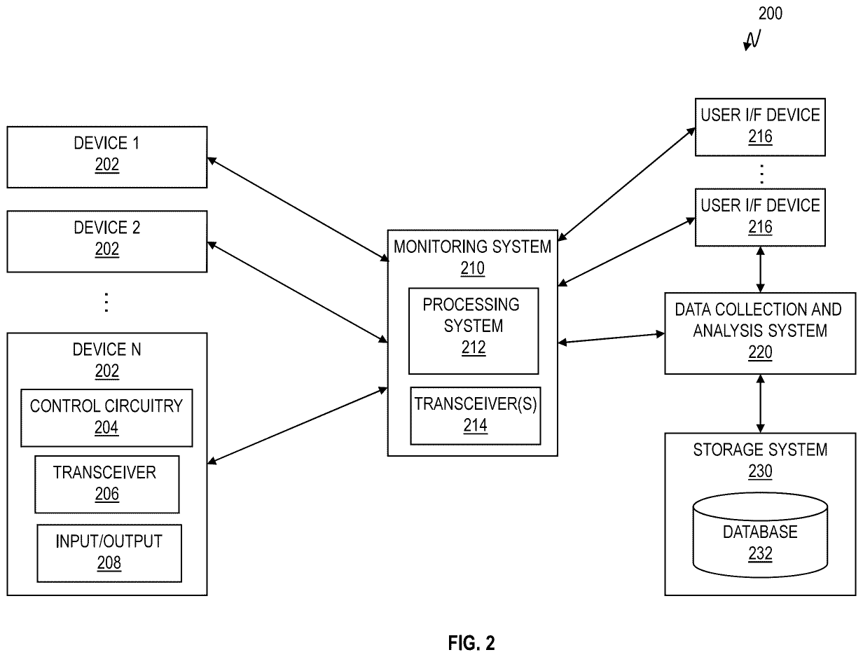

FIG. 2 is a block diagram of a system 200 in accordance with various embodiments described herein. As illustrated, the system 200 includes a monitoring system 210 that is in communication with a plurality of devices 202, such as traffic cameras 102, traffic signals 104, and/or adaptive road studs 106 of FIG. 1. Each of the devices 202 can include control circuitry 204 and a transceiver 206. The devices 202 can also include input/output 208 components, such as sensors and/or lights. The control circuitry 204 can be configured to acquire video or proximity/movement data and/or output light through the input/output 208 components, and the transceiver 206 can be configured to communicate with the monitoring system 210 and/or other devices 202.

In exemplary embodiments, the monitoring system 210 includes, among other things, a processing system 212 and one or more transceivers 214. The processing system 212 can execute instructions to determine control parameters for the devices 202 and generate alerts to one or more user interface devices 216. The processing system 212 is an example of the processing resources 110 of FIG. 1. The transceiver 214 is configured to transmit and receive signals with the transceivers 206 and/or other components. A data collection and analysis system 220 can collect and process data from the devices 202, such as video data, sensor data, and/or other such traffic data.

In exemplary embodiments, the data collection and analysis system 220 can be configured to perform time based analysis to assist in predicting future states. In exemplary embodiments, the data collection and analysis system 220 can be configured to store the traffic data (e.g., timing information, video, images, events, etc.) in a database 232 of a storage system 230 for predictions and subsequent analysis. In one embodiment, the data collection and analysis system 220 can be further configured to create and transmit an alert to one or more user interface devices 216. In some embodiments, the monitoring system and the data collection and analysis system 220 can be combined or further subdivided.

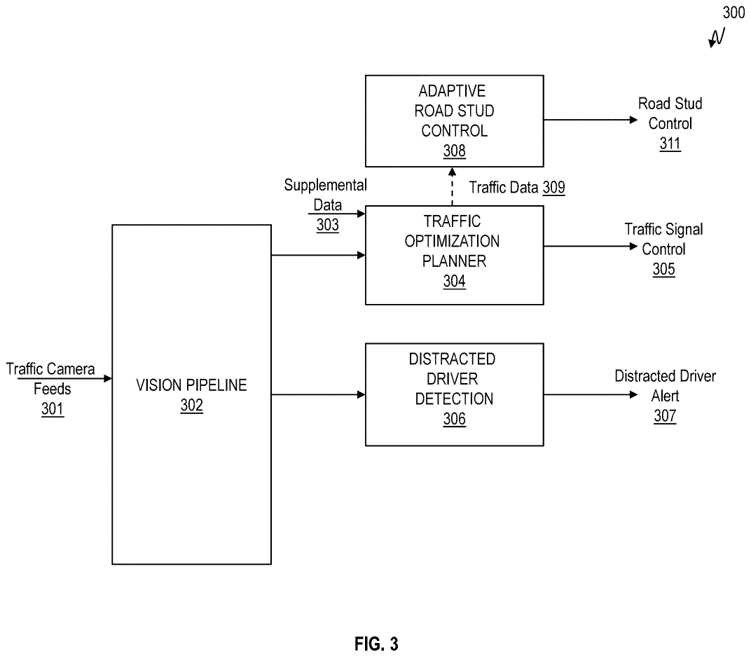

FIG. 3 is a block diagram of a control system 300 in accordance with various embodiments described herein. The control system 300 can be implemented by processing resources 110 of FIG. 1 and may be distributed between monitoring system 210 and data collection and analysis system 220 of FIG. 2.

In an embodiment, aspects of the control system 300 can include:
1. Vision Pipeline 302→Analyzes [live] traffic camera feeds 301 (video or sequence of images) from traffic cameras 102 of FIG. 1 and process these feeds to determine the position of the vehicles 108 in the feed via computer vision.
2. Traffic Optimization Planner 304→In one example, the traffic optimization planner 304 can include a five-layered fuzzy neural network with decision making (DM) to generate one or more traffic signal plans as traffic signal control 305 commands to be sent to specific instances of the traffic signals 104 to adjust light transition timing schedule. A multi-agent system approach can develop distributed unsupervised traffic responsive signal control models, where each agent in the system can be a local traffic signal controller for one intersection in the traffic network of the multi-path traffic flow area 101 of FIG. 1. The multi-agent system can be developed by integrating the simultaneous perturbation stochastic approximation theorem in fuzzy neural networks (NN). The traffic optimization planner 304 can also receive other inputs, such as supplemental data 303 that may include weather data, emergency data, and/or other such data sources.
3. Distracted Driver Detection 306→Distracted driver detection 306 can identify anomalous driving patterns from the vision pipeline 302. Successful execution can improve road safety by assisting law enforcement catch dangerous drivers, who may text while driving or driving under the influence of a controlled or illegal substance. The system can, in real-time, use computer vision to detect vehicles on the road based on the vision pipeline 302, utilize machine learning to identify vehicles 108 exhibiting dangerous behaviors characterized by exceeding an erratic vehicle operation threshold, and then notify law enforcement of suspicious vehicles as a distracted driver alert 307.
4. Adaptive Road Stud Control 308→The system can also improve the information and signaling visibility on the streets 103 of FIG. 1. This may decrease the number of traffic accidents, creating a technological alternative to replace passive reflective road studs traditionally used on roads to separate the lanes. The adaptive road studs 106 can utilize sensors or receive commands that enable the devices to change color depending on the status of the traffic signals 104 or in case of traffic jams, as well as the capability of switching a reversible lane automatically whenever possible. The adaptive road stud control 308 can receive traffic data 309 from the traffic optimization planner 304, for instance, to adapt the output of road stud control 311 for the adaptive road studs 106 to reflect traffic conditions and/or timing of traffic signals 104. In some aspects, the adaptive road stud control 308 can also have local sensors to detect conditions in proximity to the adaptive road studs 106, and the road stud control 311 can be updated accordingly.

In an embodiment, the system can be configured to use real-time data and machine learning/artificial intelligence to optimize traffic flow and to:
Adjust traffic signal 104 timing based on real-time traffic data to reduce congestion and improve traffic flow.
Predict potential road hazards, such as accidents or collisions, and take preventive measures.
Use sensors and cameras to detect traffic volume and adjust traffic light timing accordingly, reducing energy waste.

Overall, the system can be configured to provide a more efficient, safe, and sustainable traffic management solution compared to existing traffic systems. According to an embodiment, the system can be configured as follows:
Traffic Optimization Planner 304: In some aspects, traffic optimization planning can integrate the simultaneous perturbation stochastic approximation theorem into fuzzy neural networks. This can enable adaptive signal control within a multiagent system, addressing challenges associated with the infinite horizon problem and demanding continuous online learning.
Predictive Traffic Signal Control: This predictive traffic signal control can use real-time traffic data and machine learning algorithms to predict traffic flow and optimize traffic signal 104 timings accordingly. This can reduce traffic congestion and improve traffic flow.
Connected Vehicles: Connected vehicles 108 can communicate with traffic signals 104 to provide real-time data on traffic flow and vehicle location, allowing traffic signals 104 to adjust timings and optimize traffic flow.
Dynamic Queue Length Estimation: Dynamic queue length estimation can use vehicle position and movement data to estimate the length of vehicle queues at traffic signals, allowing traffic signals 104 to adjust timings and reduce congestion.
Artificial Intelligence-Based Traffic Signal Control: Artificial Intelligence-based traffic signal control involves using machine learning algorithms to optimize traffic signal timings based on real-time traffic data. This can reduce congestion, improve traffic flow, and decrease vehicle emissions.

The system may further be configured to include:
Traffic Camera Distracted Driver Alert System: The implementation of Traffic Camera Distracted Driver Detection involves leveraging machine learning and computer vision to identify anomalous driving behaviors as part of the distracted driver detection 306. This can include detecting distracted or intoxicated driving patterns through real-time analysis of traffic camera footage. Autonomous Vehicles: Autonomous vehicles have the potential to significantly reduce traffic congestion by using real-time data and machine learning algorithms to optimize traffic flow and reduce accidents caused by human error.
Vision Pipeline: The Vision Pipeline 302 can leverage computer vision techniques to provide data on vehicle 108 positions, forming a basis for optimizing traffic signal control and detecting dangerous driving behavior.
Enhanced Road Stud Capability: The adaptive road studs 106 would be equipped with sensors and can dynamically change colors based on real-time traffic conditions. This may not only increase the visibility but can also provide an opportunity to introduce the capability of automatic reversible lane switching. The capability can be managed locally at the adaptive road studs 106 and/or can be controlled or modified by the road stud control 311.

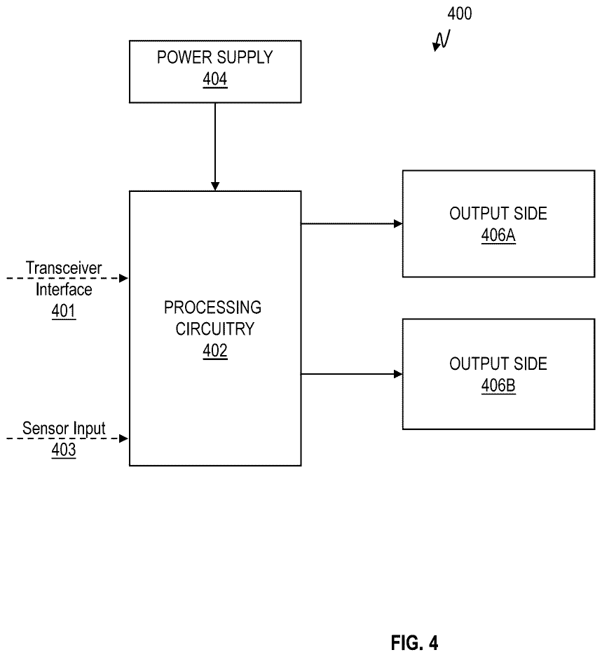

FIG. 4 is a block diagram of an adaptive road stud device 400 in accordance with various embodiments described herein, such as one or more of the adaptive road studs 106 of FIG. 1. The adaptive road stud device 400 can include processing circuitry 402, such as the control circuitry 204 of FIG. 2. The processing circuitry 402 can receive inputs from one or more of a transceiver interface 401 and sensor input 403. The transceiver interface 401 can provide signals received through transceiver 206 of FIG. 2, such as road stud control 311 of FIG. 3. The sensor input 403 can be local sensor data from input/output 208 of FIG. 2. As one example, the sensor input 403 can be from one or more sensor for traffic data collection, such as inductive loop detectors, radar sensors, magnetic sensors, infrared/acoustic sensors, lidar sensors, and/or other such sensors that detect vehicles 108 in close proximity to the associated sensor. The adaptive road stud device 400 can be powered by a power supply 404, such as a wired power supply, wireless power supply, and/or solar power supply. The processing circuitry 402 can drive different outputs for different directions of travel relative to the position of the adaptive road stud device 400. For example, output side 406A can convey different information (e.g., light color / pattern) to a vehicle 108 traveling toward the adaptive road stud device 400 in a first direction, while output side 406B can convey other information (e.g., light color/pattern) to a vehicle 108 traveling toward the adaptive road stud device 400 in a different/opposite direction.

In an embodiment, the system may also include Predictive Traffic Signal Controls, Dynamic Queue Length Estimation, Artificial Intelligence-Based Traffic Signal Control and a Traffic Optimization Planner as follows:

Predictive Traffic Signal Controls: This may provide:
Improved traffic flow: Predictive traffic signal control can help reduce traffic congestion and improve traffic flow by adjusting signal timings based on predicted traffic patterns.
Reduced emissions: By reducing the amount of time vehicles spend idling at traffic lights, predictive traffic signal control can help reduce vehicle emissions and improve air quality.
Scalability: Predictive traffic signal control can be scaled up or down easily depending on the size and complexity of the road network.
   Dynamic Queue Length Estimation: This may provide:
Real-time queue length monitoring: This Dynamic queue length estimation will provide real time monitoring of vehicle queues at intersections, allowing for accurate and timely adjustments of traffic signal timings.
Improved traffic flow: By adjusting signal timings based on real-time queue length data, dynamic queue length estimation can help reduce traffic congestion and improve traffic flow.
Reduced emissions: By reducing the amount of time vehicles spend idling at traffic lights, dynamic queue length estimation can help reduce vehicle emissions and improve air quality.
Scalability: Dynamic queue length estimation can be scaled up or down easily depending on the size and complexity of the road network.
   Artificial Intelligence-Based Traffic Signal Control: This may provide:
Real-time adjustments: Traffic Responsive Control can make real-time adjustments to signal timings based on actual traffic conditions, improving traffic flow and reducing congestion.
Increased safety: By reducing congestion and improving traffic flow, Traffic Responsive Control can help reduce the number of accidents at intersections.
Reduced emissions: By reducing the amount of time vehicles spend idling at intersections, Traffic Responsive Control can help reduce emissions and improve air quality.

Compatible with existing infrastructure: Traffic Responsive Control is often compatible with existing traffic management systems, such as traditional static traffic lights, which makes it easier to integrate the system into the larger transportation network.

Traffic Optimization Planner: This may provide:
Enhanced Traffic Flow: The traffic optimization planner can be implemented, for example, as an Simultaneous Perturbation Stochastic Approximation (SPSA)—Neural Network (NN) Traffic Optimization Algorithm can dynamically adjust signal plans based on real-time traffic conditions, improving overall traffic flow and reducing congestion.
Adaptability: The algorithm's continuous online learning capabilities allow it to adapt to changing traffic patterns, ensuring effective control even in complex scenarios.

Hierarchical Structure: The hierarchical structure of the SPSA-NN-based multiagent system provides a regional perspective, facilitating collaboration beyond assigned zones.

According to various embodiments, an evaluation process may include 1) predictive traffic control and 2) SPSA-NN-based traffic signal control, which consider:

### Prediction Horizon:

A critical distinction lies in the prediction horizon. Predictive traffic control primarily focuses on a short distance ahead, typically the next few minutes, for predicting traffic flow and adjusting signals. In contrast, the SPSA-NN-based traffic signal control demonstrates the capability to extend the prediction horizon much further, reaching hours or even days. This allows for a more comprehensive prediction of traffic flow patterns and subsequent adjustments to signal timings.

### Algorithm Complexity:

The complexity of the algorithms utilized distinguishes these approaches. Predictive traffic control relies on simpler algorithms, often incorporating linear regressions or time series analysis. Conversely, the SPSA-NN-based traffic signal control demands the development of more intricate algorithms, such as neural networks or reinforcement learning. This complexity enhances the optimization of traffic signal timings.

### Training Data:

Predictive traffic control primarily relies on historical traffic data and flow patterns for predictions. In contrast, the SPSA-NN-based traffic signal control can incorporate both historical and real-time traffic data. This enables the machine learning algorithms to be trained on a more diverse and dynamic dataset, contributing to improved adaptability.

### Adaptability:

The adaptability factor can be considered. The SPSA-NN-based traffic signal control can exhibit adaptability by learning and adjusting to changing traffic patterns and behaviors over time. This can assist in addressing unexpected events or abrupt changes in traffic conditions, showcasing its robust performance in dynamic scenarios.

In an embodiment, the SPSA-NN-based traffic signal control approach is a robust solution due to its anticipated complexity, adaptability, extended prediction horizon, and the ability to learn from a diverse dataset comprising both historical and real-time traffic data. The SPSA-NN-based system is driven by its adaptability and the advantage of fewer infrastructure changes, addressing critical considerations in optimizing traffic signal control.

### #1—Vision Pipeline Iteration

### Embodiment 1

In the initial iteration of a computer vision pipeline (CVP), the Distracted Driver Alert System (DDAS) started a background modeling phase by processing standard MP4 or MOV video files. The system read video files, converted them into individual frames, and processed them for subsequent analysis. To optimize memory usage, a buffer of frames was loaded into a vector upon startup, typically containing around 100 frames. The process involved generating a Background Model using the Median Model (BMM), where the system calculated the median value for each pixel based on historical data from the buffer. The BMM, generated every 1.5 minutes, played a crucial role in background subtraction, capturing the road background effectively and avoiding ghosting issues.

This Embodiment included:
Performance and Efficiency: The use of a buffer for storing frames may consume a significant amount of RAM, and the size of the buffer could affect the efficiency and training time. To address this, optimizing the buffer size and memory usage is essential.
False Positives with Traditional GMM: The traditional Gaussian Mixture Model (GMM) may result in false positives due to its inability to adapt to changing conditions. Considering alternative models or refining the existing one could help reduce false positives; and
Adaptability to Environmental Changes: While the system accounts for changing weather conditions by generating a new Background Model Median every 1.5 minutes, there might be scenarios where rapid changes occur. Enhancements could involve making the system more adaptive to sudden environmental changes.

It should be appreciated that he buffer size and memory usage can be optimized through a refined approach. Other embodiments introduce an adaptive buffer management system that dynamically adjusts based on computational needs, optimizing RAM utilization. Addressing concerns about rapid environmental changes, future versions could incorporate an improved adaptive mechanism. A real-time weather condition analysis module is possible, which would allow the system to dynamically adjust to sudden changes.

### Embodiment 2

The second embodiment of DDAS's CVP marked a significant enhancement, incorporating advanced algorithms to improve background modeling and object detection. The ViBe algorithm, a commercial background subtraction method, was introduced to create a detailed background model. The system implemented the Sliding Window Neighbor Detector (SWND), a custom recursive algorithm designed for efficient image cleaning. SWND filled holes, removed noise, and ensured the quality of object outlines, contributing to the precision of the detection process. Additionally, the Canny Contour Detector was integrated to identify vehicle outlines accurately in binary images, enhancing the system's capability to handle diverse traffic scenarios and lighting conditions.

This Embodiment included:
Real-Time Weather Analysis Precision: Despite efforts to improve adaptability, accurately predicting sudden weather changes in real-time remains a complex challenge, impacting the system's reliability in dynamic weather scenarios, however this would not be an issue in almost any urban network.
Dependency on GPU Resources: While GPU acceleration enhances processing speed, it may limit accessibility for users with hardware constraints, posing a challenge for those without compatible GPUs.

Potential challenges include the need for improved weather prediction algorithms to enhance real-time accuracy and considerations for diversifying computation options to cater to a broader range of hardware configurations. To address these issues, the system proposes enhancements such as incorporating additional weather data sources and optimizing algorithms for CPU processing while exploring cloud-based solutions for scalability. These measures not only tackle the identified challenges but also align with sustainability principles by enhancing system accessibility and adaptability to diverse computing environments

### Embodiment 3

In the third embodiment, DDAS's CVP underwent comprehensive refinements, solidifying its role as a sophisticated real-time traffic analysis system. The background modeling phase was further enriched by incorporating multiple background subtraction methods, including Median Model (BMM), Gaussian Models (MOG1 and MOG2), and ViBe. Each method contributed to the system's adaptability to varying environmental conditions. The Sliding Window Neighbor Detector (SWND) was optimized to efficiently clean data, reducing noise and improving overall object detection. The Canny Contour Detector's integration provided higher precision identification of vehicle outlines, culminating in a robust CVP capable of handling complex real-world traffic scenarios with heightened accuracy and reliability.

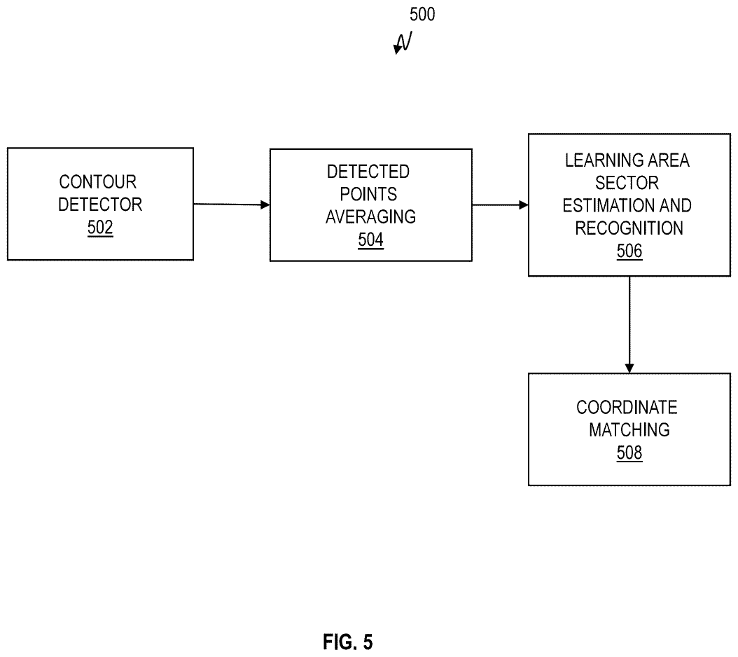

FIG. 5 is a block diagram of a vision pipeline 500 in accordance with various embodiments described herein. The vision pipeline 500 can be a portion of the vision pipeline 302 of FIG. 3. In the example of FIG. 5, the vision pipeline 500 includes a contour detector 502, such as Canny contour detector, detected points averaging 504, learning area sector estimation and recognition 506, and coordinate matching 508.

Canny Contour Detection→This can be performed by the contour detector 502. Utilizing the Canny contour detector, the system can identify the outlines to detect individual vehicles 108 as distinct objects. A raw threshold can be applied to eliminate objects that are too small to be considered vehicles. Objects located on the periphery, where a complete detection is not yet feasible, can be excluded. This ensures that anomaly detection occurs after obtaining a robust and accurate detection. Following the detection of Canny contours, center points of these contours are stored in a global vector of points using detected points averaging 504. This method can facilitate the compilation of every detected vehicle, using various Computer Vision methods, into a single vector.

In an embodiment, a custom algorithm, LASER for Learning Area Sector Estimation and Recognition 506, can be used. LASER divides the image into sectors to create a model of where vehicles are located in each sector. One of the central qualities of LASER is an ability to adapt and function effectively in a diverse array of traffic situations. An area sector model can be used, where an image is partitioned into sectors of pixels (e.g., 7 pixels) by the size of one lane's width. This may result in entering the number of lanes into the system. A grid can be established where a vehicle 108 is categorized into the lane it is traveling in, and every general area, N pixels (e.g., 7 pixels) across, contributes to an updated model of where most vehicles 108 are located when passing through each sector. This continuous updating enhances accuracy over time. The model is designed to apply thresholds to determine if a vehicle 108 is outside the safe range, enabling intelligent application in scenes with various roads, directions, and speeds. LASER can include angular and movement data, in addition to position data, for each individual sector. LASER is valuable as an infrastructure capable of utilizing any metric and saving it into sectors. LASER and LASER Enforcement can operate using raw thresholds and learned models, generated with a vector of positions entered by the user indicating the boundaries between each lane, and run on the main thread. Coordinate matching 508 can map determined values back to physical locations of the multi-path traffic flow area 101 of FIG. 1.

### #2—Distracted Driver Alert System (DDAS)

### Iteration 1: Basic Movement Property Detection System

In an initial iteration of a Movement Property Detection System, the focus is on implementing a basic framework for recognizing movement properties of vehicles 108. The system can utilize simple averaging algorithms to accumulate x and y movements, learning the normal ranges for these properties as part of distracted driver detection 306 of FIG. 3. A goal can be to identify excessive movements and changes in acceleration, which can be indicative of distracted or impaired driving. The system can also incorporate angular movement detection to understand directional acceleration. Speed calculations can be introduced using the Pythagorean Theorem. Anomalous movement detection is primarily based on hard thresholds for individual displacement, allowing quick identification of erratic behaviors. The iteration aims to establish a foundation for further enhancements.

### Iteration 2: Enhanced Anomaly Detection

Building upon the basic framework, the second iteration focuses on enhancing anomaly detection mechanisms. The system introduces a learned model detection approach, comparing active movement with the learned model. Proportional and absolute distance-based methods are employed to recognize anomalies, increasing the system's sensitivity. The iteration also incorporates a sophisticated frame-based anomaly recording system, ensuring that anomalies are detected consistently over an extended period. Confidence metrics, considering the duration and magnitude of anomalous behavior, are introduced to refine anomaly detection accuracy. This iteration aims to reduce false positives and improve the system's ability to identify prolonged erratic driving patterns.

### Iteration 3: Processing Optimization and Scalability

In the third iteration, the emphasis is on optimizing the processing pipeline and introducing scalability measures. Multi-threading is implemented to distribute the processing load across multiple cores efficiently. The system can use a pthread library to manage threads for different major tasks. Each significant step in the Computer Vision process can be assigned its thread handler, allowing parallel execution. This iteration enhances the system's speed and responsiveness, making it more scalable for future updates and additional processing steps. The abstract thread handler design can ensure that new methods can be seamlessly integrated, promoting continuous updates and improvements to the system's capabilities. The iteration aims to enhance overall system efficiency and adaptability.

One of the challenges faced in developing the Distracted Driver Alert System (DDAS) was the limited availability of footage for testing. To address this, artificially generated footage simulating distracted driving was created. Software was used to edit in vehicles with tracks that emulated drivers with various levels of distraction or under the influence of substances. Using the path-editing tool, a vehicle was edited in to show it swerving through the frame, as well as speeding through the frame. The system, DDAS, was then tested on 36 different anomalous vehicle paths, with 34 accurately flagged and 4 false positives. The data gathered is extremely straightforward. The overall accuracy rate was 83.33% or 30/36 true positives. Notably, the angle detector, capable of identifying small motions leading to large anomalous motions, proved to be the most accurate among the anomaly detectors.

The impact of DDAS on addressing intoxicated and distracted driving is significant. The system's scalability and efficient use of algorithms make it applicable to cities of different sizes. DDAS leverages current resources, utilizing technology to aid law enforcement without the need for constant human monitoring. The system is designed to prioritize privacy, recording license plates, and sharing data with humans when anomalous behavior is detected. In conclusion, DDAS represents a technical advancement in combating the critical issues of distracted and intoxicated driving.

### #3—Application of SPSAA-NN Model in Traffic Signal Regulation for Traffic Optimization Planner 304

### Iteration 1: SPSA-NN Model

This portion used 1 iteration because the initial implementation of the SPSA-NN traffic regulation model demonstrated exceptional adaptability and efficiency. The algorithm's unique combination of Simultaneous Perturbation Stochastic Approximation principles and neural network capabilities proved highly effective in addressing the complexities of traffic dynamics.

Research/Preliminary Analysis: In dealing with the intricate traffic signal control problem, a multiagent system for real-time traffic signal control could frame the challenge as an infinite horizon distributed control problem. Computational intelligence-based approaches, including fuzzy sets, genetic algorithms, reinforcement learning, and neural networks, have been previously proposed. Machine learning optimization can refining machine learning models, aiming to achieve maximum accuracy and minimum error. Optimization involves iteratively training the model to attain maximum and minimum function evaluations. This process is integral to obtaining better results in machine learning, emphasizing the importance of continuous improvement.

The goal of optimizing machine learning models is to compare results in each iteration by altering the model until optimal outcomes are reached. The focus is on creating an accurate model with a lower error rate. Different optimization algorithms, such as Gradient Descent and Stochastic Gradient Descent, play a crucial role in achieving this. In the context of optimization, maxima and minima are significant, representing the largest and smallest values of a function within a given range. Global maxima and minima span the entire domain, while local maxima and minima exist within a specified range.

Gradient Descent, as an optimization algorithm, targets the local minima of a differentiable function. By analyzing the geometric intuition of slopes in a graph, it navigates towards minima by iteratively updating points. The learning rate, a hyperparameter, determines the step size during each iteration. Learning rate, a critical aspect of optimization, influences the step size in moving towards minima. Effective tuning of hyperparameters ensures that machine learning models are aligned with specific use cases and datasets. The iterative refinement process aims to achieve maximum accuracy, minimum errors, and efficient model performance.

In an embodiment, optimization algorithms like Gradient Descent and Stochastic Gradient Descent can be used to achieve accurate and efficient machine learning models.

In the realm of traffic optimization, the infinite horizon problem poses a significant challenge. When employing multiagent systems for real-time, distributed, and unsupervised traffic-responsive signal control models, each agent, serving as a local traffic signal controller for a specific intersection, faces the task of continuous online learning once integrated into the traffic network. The infinite horizon problem arises when these agent-based controllers operate indefinitely, adapting to changing traffic conditions over time. The complexity intensifies due to the interdependency of each intersection on its neighbors, making it crucial to set optimal signal parameter values for a large, complex traffic network with multiple intersections. The challenge lies in developing adaptive systems that can not only assess both microscopic and macroscopic traffic states but also continuously adjust various traffic signal control parameters in response to varying traffic demand, all while preventing congestion and ensuring efficient traffic flow. Addressing the infinite horizon problem becomes crucial for the efficacy of traffic signal control systems in large-scale networks. The algorithm does not know how far or the “time horizon” to optimize traffic for as traffic is continuous and non-stopping.

Simultaneous Perturbation Stochastic Approximation (SPSA) is a versatile optimization method designed for minimizing differentiable multivariate functions, especially those where computing the gradient is challenging or resource-intensive. Unlike traditional finite-difference methods, SPSA employs a stochastic approach to approximate the gradient of the cost function by evaluating the function twice using perturbed parameter vectors. The key distinction is that every component of the original parameter vector is simultaneously shifted with randomly generated values during each evaluation. SPSA operates iteratively, starting with an initial parameter vector and updating it using a rule similar to standard gradient descent. What sets SPSA apart is its robustness to noise in function measurements, making it suitable for scenarios where the cost function may have perturbations. The perturbation in SPSA is introduced through a stochastic estimate of the gradient, where each parameter is simultaneously perturbed by a random value. This inherent stochasticity helps absorb noise into the optimization process, as illustrated by the distinctive path SPSA takes through the function space compared to traditional gradient-based optimizers.

Simultaneous Perturbation Stochastic Approximation (SPSA) can be a valuable tool for addressing the intricate challenges of traffic optimization. Traffic control systems can face the daunting task of managing dynamic and stochastic traffic conditions, with sophisticated optimization techniques. As detailed above, SPSA's strength lies in its ability to navigate noisy and unpredictable traffic data, offering a robust optimization approach that aligns with the inherent uncertainties on the road. This can be particularly beneficial in the context of traffic signal control, where precise modeling of traffic patterns is challenging due to the constantly changing nature of congestion and vehicle movements. SPSA's simultaneous perturbation methodology, involving the random adjustment of all parameters at once, facilitates a comprehensive exploration of the complex parameter space associated with optimizing traffic signal timings.

Furthermore, the iterative nature of SPSA provides a well-suited framework for the continuous adaptation in traffic optimization. Traffic conditions exhibit temporal variations, and SPSA's iterative optimization process allows for real-time adjustments based on the evolving state of the traffic network. This adaptability proves crucial in tackling the infinite horizon problem in traffic optimization, where controllers must continuously refine their strategies to ensure long-term efficiency. By incorporating SPSA into traffic control algorithms, it becomes possible to enhance the responsiveness, adaptability, and overall efficiency of traffic management systems, contributing to safer and more streamlined urban mobility.

Fuzzy Logic and Decision-Making can play a pivotal role in addressing the complexities inherent in decision-making processes, particularly in contexts where uncertainty and imprecision are prevalent. Fuzzy Logic, a mathematical framework inspired by human reasoning, allows for the representation of vague and ambiguous information, making it well-suited for applications where traditional binary logic falls short. In the realm of traffic optimization, FNN offers a valuable approach to handling the inherent uncertainties associated with real-world traffic dynamics. Traffic conditions often involve imprecise data, and FNN excels in capturing and processing this uncertainty, enabling more nuanced decision-making in traffic control systems.

Fuzzy Neural Networks (FNN) further extend the capabilities of fuzzy logic by integrating neural network principles. This amalgamation can enhance the adaptive learning and pattern recognition capabilities of the system. In traffic optimization scenarios, FNN can efficiently model and learn complex relationships within the traffic data, allowing for more informed and context-aware decision-making. The incorporation of fuzzy logic and neural networks empowers traffic management systems to make decisions based on a holistic understanding of the dynamic and evolving traffic environment. Ultimately, FNN contributes to the creation of intelligent and responsive traffic control systems that can navigate the uncertainties inherent in urban traffic scenarios, leading to improved efficiency and safety in transportation networks.

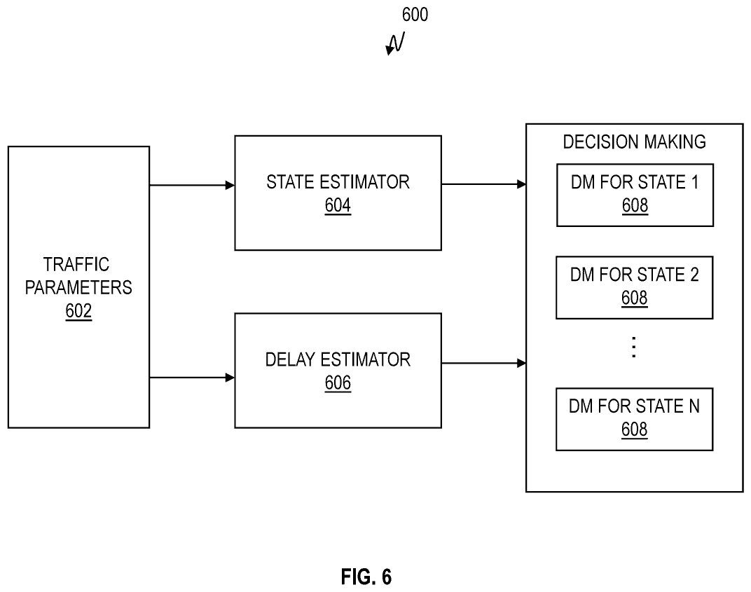

FIG. 6 is a block diagram of an agent 600 of traffic planner model in accordance with various embodiments described herein. In the example of FIG. 6, the agent 600 includes traffic parameters 602 that are provided to a state estimator 604 and a delay estimator 606. State and delay estimates can be provided to perform decision making 608 on a per state basis. Each agent 600 can use a multi-layer fuzzy neural network for decision making 608. Cost functions can be used to evaluate performance by considering changes in average delays over different stages. As one example, a traffic network can be described as a directed graph with a set of nodes and links. Each node can be a traffic signal at an intersection, where an agent controls each node. There can be multiple temporal stages. Various inputs can be set for the traffic parameters 602. Traffic parameters 602 can define lane configurations (e.g., number of lanes, straight/turn), traffic volume, future volume, targeted volume, lengths, right-on-red permissions, peak hours, turning speed, crosswalks, multiple turn lane configuration, surge traffic adjustments, approach delay, control delay, queue delay, pedestrian crossing times, signal delay, capacity utilization, and/or other such factors.

It should be appreciated that, in an embodiment, the evaluation of systems developed in this study focuses on two key performance measures: Mean delay of vehicles and mean stoppage time of vehicles.

Utilizing a microscopic traffic simulation platform, PARAMICS, detailed measurements of various parameters for each vehicle entering and leaving the traffic network were recorded. The mean delay of vehicles (T_{MD}) was calculated as T_{MD}=T_{D}/T_{V}, where T_{MD} represents the mean delay, T_{D} is the total delay, and T_{V} is the total number of vehicles entering and leaving the network during the measurement period.

Similarly, the mean stoppage time for vehicles (T_{MST}) was calculated as T_{MST}=T_{ST}/T_{V}, where T_{MST} is the mean stoppage time, T_{ST} is the total stoppage time, and T_{V} is the total number of vehicles entering and leaving the network during the measurement period. The current vehicle mean speed, equivalent to the instantaneous speed of a vehicle, was determined as the average speed of all vehicles currently in the traffic network. These performance measures offer insights into the overall traffic conditions, with high total mean delay and low current mean speed indicative of an over-congested traffic network. This was used to evaluate the effectiveness of the novel method developed through an SPSA-NN.

The system, DDAS, was then tested on 36 different anomalous vehicle paths, with 34 accurately flagged and 4 false positives. The data gathered is extremely straightforward. The overall accuracy rate was 83.33% or 30/36 true positives. Notably, the angle detector, capable of identifying small motions leading to large anomalous motions, proved to be the most accurate among the anomaly detectors.

In a simulation of Miami's CBD area using PARAMICS Modeler 4.0, the SPSA-NN-based multiagent system excelled in various scenarios. Three-hour simulations showed superior performance in total mean delay and end-of-simulation speed compared to the GLIDE benchmark. In 6-hour simulations, the multiagent systems demonstrated consistency, while GLIDE exhibited degradation. The challenging 24-hour simulations revealed that both systems experienced performance degradation, but the SPSA-NN system showed remarkable adaptability with a 78% reduction in mean delay. Continuous online learning capabilities of the SPSA-NN system were evident in the infinite horizon problem scenario. The system's nonhierarchical structure and fixed cooperative zones facilitated effective traffic management in 24-hour simulations, outperforming GLIDE. However, limitations in gaining a regional perspective were noted due to the restricted communication channels within each zone.

The collection of valid data may be accomplished through the vision pipeline. For the model to function and be trained properly, the quality of data must be at a certain level. If the data accuracy decreases, then the model will fail to perform as it cannot make accurate predictions of false data.

Embodiments can enhance the landscape of urban transportation by addressing critical challenges in real-time traffic signal control, road safety, and traffic accident prevention. This multidimensional approach combines cutting-edge technologies, including computer vision, machine learning, and advanced optimization algorithms, to create a comprehensive and intelligent system that not only optimizes traffic flow but also ensures road safety and minimizes traffic accidents.

Although the application of intelligence into traffic management has been experimented with before, in previous attempts, the data being passed into the ML Model came from various sensors with upfront investment including infrastructure changes. In an embodiment, the data the ML Model receives is done through a camera running software in order to detect vehicles. Furthermore, these attempts were lacking in terms of AI. Meaning that the systems used simple linear regression models or pose estimation which was there to supplement a static system. On the other hand, embodiments may involve a much more complex AI which is the decision maker for the system and doesn't depend on any externalities.

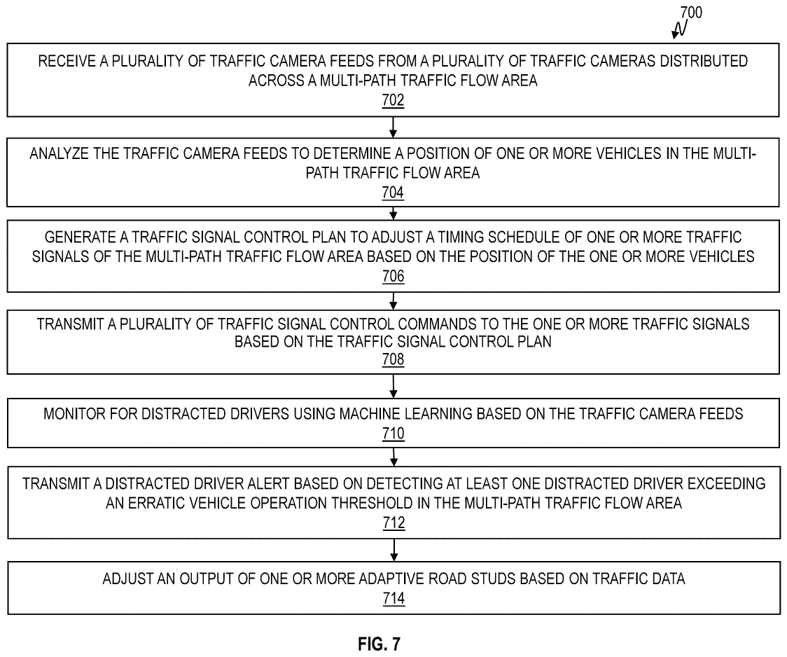

FIG. 7 is a flow diagram of a computer-implemented method 700 according to one or more embodiments described herein. At block 702, a system can receive a plurality of traffic camera feeds from a plurality of traffic cameras distributed across a multi-path traffic flow area. At block 704, the system can analyze the traffic camera feeds to determine a position of one or more vehicles in the multi-path traffic flow area. At block 706, the system can generate a traffic signal control plan to adjust a timing schedule of one or more traffic signals of the multi-path traffic flow area based on the position of the one or more vehicles. At block 708, the system can transmit a plurality of traffic signal control commands to the one or more traffic signals based on the traffic signal control plan. At block 710, the system can monitor for distracted drivers using machine learning based on the traffic camera feeds. At block 712, the system can transmit a distracted driver alert based on detecting at least one distracted driver exceeding an erratic vehicle operation threshold in the multi-path traffic flow area. At block 714, an output of one or more adaptive road studs can be adjusted based on traffic data.

In some aspects, analyzing the traffic camera feeds can include performing contour detection to identify outlines of the one or more vehicles as located objects, applying a size based threshold to eliminate classification of the located objects based on determined sizes of the outlines, applying detected points averaging to track locations of the located objects, identifying positions of the located objects relative to lanes of travel, and applying coordinate matching to map the positions of the located objects to the multi-path traffic flow area.

In some aspects, generating the traffic signal control plan can include using simultaneous perturbation stochastic approximation with neural networks to model and adapt traffic signal timing.

In some aspects, the traffic signal control plan for each of the traffic signals can be developed in part using a multi-agent approach with each agent utilizing traffic parameters provided to a state estimator and a delay estimator and context-aware decision making for a plurality of states over a time horizon across the multi-path traffic flow area.

In some aspects, monitoring for distracted drivers can include tracking movement and changes of direction of travel, speed, and acceleration relative to a learned model for distracted drivers detection.

In some aspects, the operations can include adjusting an output of one or more adaptive road studs based on traffic data determined by one or more of a sensor input and a data associated with the traffic signal control plan.

In some aspects, the one or more adaptive road studs can be positioned between travel lanes of the multi-path traffic flow area, and the one or more adaptive road studs can include processing circuitry configured to change an output lighting on one or more sides of the one or more adaptive road studs to visually indicate one or more of: a road hazard, traffic congestion, and a state of one or more of the traffic signals in a corresponding direction of travel.

In accordance with an exemplary embodiment, the system may be implemented through a controller operating in response to a computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing. Moreover, the system may be embodied in the form of a computer or controller implemented processes.

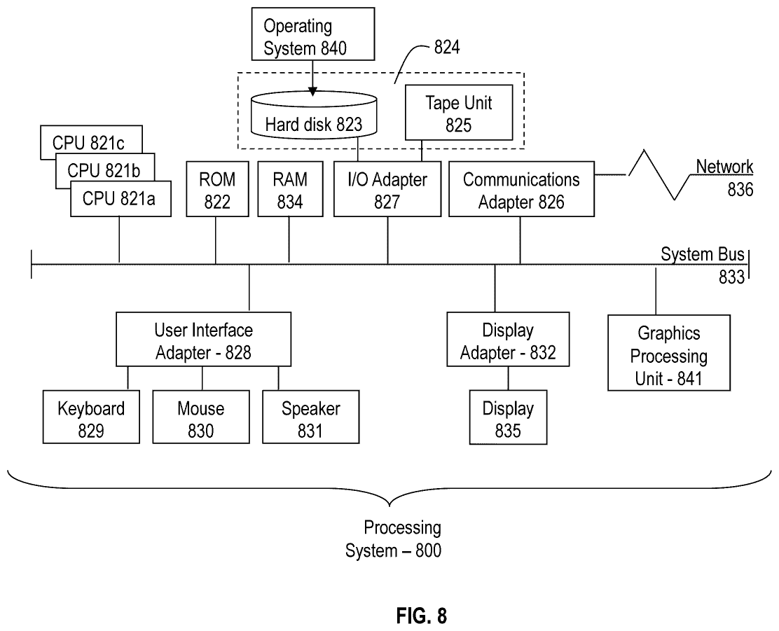

Referring to FIG. 8, there is shown an embodiment of a processing system 800 for implementing the teachings herein. In this embodiment, the system 800 has one or more central processing units (processors) 821a, 821b, 821c, etc. (collectively or generically referred to as processor(s) 821). In one or more embodiments, each processor 821 may include a reduced instruction set computer (RISC) microprocessor. Processors 821 are coupled to system memory 834 and various other components via a system bus 833. Read only memory (ROM) 822 is coupled to the system bus 833 and may include a basic input/output system (BIOS), which controls certain basic functions of systems of FIGS. 1-6.

FIG. 8 further depicts an input/output (I/O) adapter 827 and a network adapter 826 coupled to the system bus 833. I/O adapter 827 may be a small computer system interface (SCSI) adapter that communicates with a hard disk 823 and/or tape storage drive 825 or any other similar component. I/O adapter 827, hard disk 823, and tape storage device 825 are collectively referred to herein as mass storage 824. Operating system 840 for execution on the processing system 800 may be stored in mass storage 824. A network adapter 826 interconnects bus 833 with an outside network 836 enabling the processing system 800 to communicate with other such systems. A screen (e.g., a display monitor) 835 can be connected to system bus 833 by display adaptor 832, which may include a graphics adapter to improve the performance of graphics intensive applications and a video controller. In one embodiment, adapters 827, 826, and 832 may be connected to one or more I/O busses that are connected to system bus 833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 833 via user interface adapter 828 and display adapter 832. A keyboard 829, mouse 830, and speaker 831 all interconnected to bus 833 via user interface adapter 828, which may include, for example, a Super I/O chip integrating multiple device adapters into a single integrated circuit.

In exemplary embodiments, the processing system 800 can include a graphics processing unit 841. Graphics processing unit 841 is a specialized electronic circuit designed to manipulate and alter memory to accelerate the creation of images in a frame buffer intended for output to a display. In general, the graphics processing unit 841 is very efficient at manipulating computer graphics and image processing and has a highly parallel structure that makes it more effective than general-purpose CPUs for algorithms where the processing of large blocks of data is done in parallel. Further, the processing capabilities of the graphics processing unit 841 can be used to execute one or more machine learning models.

Thus, as configured in FIG. 8, the system 800 includes processing capability in the form of processors 821, storage capability including system memory 834 and mass storage 824, input means such as keyboard 829 and mouse 830, and output capability including speaker 831 and display 835. In one embodiment, a portion of system memory 834 and mass storage 824 collectively store an operating system to coordinate the functions of the various components shown in FIG. 8.

The methods and embodiments of the invention described herein and illustrated in the several figures may be embodied in the form of computer-implemented processes and apparatuses for practicing those processes. As such, the methods and embodiments described hereinabove and in the several figures may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention.

The methods and embodiments described hereinabove and in the several figures may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. It should be further appreciated that the methods and embodiments described hereinabove may also be practiced, in whole or in part, via any device suitable to the desired end purpose, such as a computer, iPod, MP3 Player, a PDA, a Pocket PC, Tablet PC, Smartphone and/or a Cell phone with connection capability.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be appreciated that while the invention has been described with reference to an exemplary embodiment, it will be understood by those skilled in the art that various changes, omissions and/or additions may be made, and equivalents may be substituted for elements thereof without departing from the spirit and scope of the invention. Moreover, the embodiments or parts of the embodiments may be combined in whole or in part without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A system to provide urban transportation control, the system comprising:
at least one processor; and
memory coupled to the at least one processor and storing instructions that, when executed by the at least one processor, cause the system to perform a plurality of operations comprising:
receiving a plurality of traffic camera feeds from a plurality of traffic cameras distributed across a multi-path traffic flow area;
analyzing the traffic camera feeds to determine a position of one or more vehicles in the multi-path traffic flow area;
generating a traffic signal control plan to adjust a timing schedule of one or more traffic signals of the multi-path traffic flow area based on the position of the one or more vehicles;
transmitting a plurality of traffic signal control commands to the one or more traffic signals based on the traffic signal control plan;
monitoring for distracted drivers using machine learning based on the traffic camera feeds; and
transmitting a distracted driver alert based on detecting at least one distracted driver exceeding an erratic vehicle operation threshold in the multi-path traffic flow area.

2. The system of claim 1, wherein analyzing the traffic camera feeds comprises:
performing contour detection to identify outlines of the one or more vehicles as located objects;
applying a size based threshold to eliminate classification of the located objects based on determined sizes of the outlines;
applying detected points averaging to track locations of the located objects;
identifying positions of the located objects relative to lanes of travel; and
applying coordinate matching to map the positions of the located objects to the multi-path traffic flow area.

3. The system of claim 1, wherein generating the traffic signal control plan comprises using simultaneous perturbation stochastic approximation with neural networks to model and adapt traffic signal timing.

4. The system of claim 3, wherein the traffic signal control plan for each of the traffic signals is developed in part using a multi-agent approach with each agent utilizing traffic parameters provided to a state estimator and a delay estimator and context-aware decision making for a plurality of states over a time horizon across the multi-path traffic flow area.

5. The system of claim 1, wherein monitoring for distracted drivers comprises tracking movement and changes of direction of travel, speed, and acceleration relative to a learned model for distracted drivers detection.

6. The system of claim 1, the operations further comprise:
adjusting an output of one or more adaptive road studs based on traffic data determined by one or more of a sensor input and a data associated with the traffic signal control plan.

7. The system of claim 6, wherein the one or more adaptive road studs are positioned between travel lanes of the multi-path traffic flow area, and the one or more adaptive road studs comprise processing circuitry configured to change an output lighting on one or more sides of the one or more adaptive road studs to visually indicate one or more of: a road hazard, traffic congestion, and a state of one or more of the traffic signals in a corresponding direction of travel.

8. A computer-implemented method comprising:
receiving a plurality of traffic camera feeds from a plurality of traffic cameras distributed across a multi-path traffic flow area;
analyzing the traffic camera feeds to determine a position of one or more vehicles in the multi-path traffic flow area;
generating a traffic signal control plan to adjust a timing schedule of one or more traffic signals of the multi-path traffic flow area based on the position of the one or more vehicles;
transmitting a plurality of traffic signal control commands to the one or more traffic signals based on the traffic signal control plan;
monitoring for distracted drivers using machine learning based on the traffic camera feeds; and
transmitting a distracted driver alert based on detecting at least one distracted driver exceeding an erratic vehicle operation threshold in the multi-path traffic flow area.

9. The computer-implemented method of claim 8, wherein analyzing the traffic camera feeds comprises:
performing contour detection to identify outlines of the one or more vehicles as located objects;
applying a size based threshold to eliminate classification of the located objects based on determined sizes of the outlines;
applying detected points averaging to track locations of the located objects;
identifying positions of the located objects relative to lanes of travel; and
applying coordinate matching to map the positions of the located objects to the multi-path traffic flow area.

10. The computer-implemented method of claim 8, wherein generating the traffic signal control plan comprises using simultaneous perturbation stochastic approximation with neural networks to model and adapt traffic signal timing.

11. The computer-implemented method of claim 10, wherein the traffic signal control plan for each of the traffic signals is developed in part using a multi-agent approach with each agent utilizing traffic parameters provided to a state estimator and a delay estimator and context-aware decision making for a plurality of states over a time horizon across the multi-path traffic flow area.

12. The computer-implemented method of claim 8, wherein monitoring for distracted drivers comprises tracking movement and changes of direction of travel, speed, and acceleration relative to a learned model for distracted drivers detection.

13. The computer-implemented method of claim 8, further comprising:
adjusting an output of one or more adaptive road studs based on traffic data determined by one or more of a sensor input and a data associated with the traffic signal control plan.

14. The computer-implemented method of claim 13, further comprising:
changing an output lighting on one or more sides of the one or more adaptive road studs to visually indicate one or more of: a road hazard, traffic congestion, and a state of one or more of the traffic signals in a corresponding direction of travel.

15. A computer program product comprising a non-transitory computer readable medium storing instructions that, when executed by a computer system, cause the computer system to perform operations comprising:
receiving a plurality of traffic camera feeds from a plurality of traffic cameras distributed across a multi-path traffic flow area;
analyzing the traffic camera feeds to determine a position of one or more vehicles in the multi-path traffic flow area;
generating a traffic signal control plan to adjust a timing schedule of one or more traffic signals of the multi-path traffic flow area based on the position of the one or more vehicles;
transmitting a plurality of traffic signal control commands to the one or more traffic signals based on the traffic signal control plan;
monitoring for distracted drivers using machine learning based on the traffic camera feeds; and
transmitting a distracted driver alert based on detecting at least one distracted driver exceeding an erratic vehicle operation threshold in the multi-path traffic flow area.

16. The computer program product of claim 15, wherein analyzing the traffic camera feeds comprises:
performing contour detection to identify outlines of the one or more vehicles as located objects;
applying a size based threshold to eliminate classification of the located objects based on determined sizes of the outlines;
applying detected points averaging to track locations of the located objects;
identifying positions of the located objects relative to lanes of travel; and
applying coordinate matching to map the positions of the located objects to the multi-path traffic flow area.

17. The computer program product of claim 15, wherein generating the traffic signal control plan comprises using simultaneous perturbation stochastic approximation with neural networks to model and adapt traffic signal timing, and the traffic signal control plan for each of the traffic signals is developed in part using a multi-agent approach with each agent utilizing traffic parameters provided to a state estimator and a delay estimator and context-aware decision making for a plurality of states over a time horizon across the multi-path traffic flow area.

18. The computer program product of claim 15, wherein monitoring for distracted drivers comprises tracking movement and changes of direction of travel, speed, and acceleration relative to a learned model for distracted drivers detection.

19. The computer program product of claim 15, wherein the operations further comprise:
adjusting an output of one or more adaptive road studs based on traffic data determined by one or more of a sensor input and a data associated with the traffic signal control plan.

20. The computer program product of claim 19, wherein the operations further comprise:
changing an output lighting on one or more sides of the one or more adaptive road studs to visually indicate one or more of: a road hazard, traffic congestion, and a state of one or more of the traffic signals in a corresponding direction of travel.
